(19) United States
(12) Patent Application Publication
(10) Pub. No.: US 2011/0186011 A1
(43) Pub. Date: Aug. 4, 2011

(54) INTERNAL COMBUSTION ENGINE

(75) Inventors: Yasuyuki KUBO, SAITAMA (JP); Junichi KAMIO, SAITAMA (JP)

(73) Assignee: HONDA MOTOR CO., LTD., TOKYO (JP)

(21) Appl. No.: 13/007,781

(22) Filed: Jan. 17, 2011

(30) Foreign Application Priority Data
Feb. 3, 2010 (JP) 2010-022323
Feb. 3, 2010 (JP) 2010-022324
Feb. 3, 2010 (JP) 2010-022325

(51) Int. Cl. F02M 43/04

(52) U.S. Cl. 123/445

(57) ABSTRACT

Provided is an internal combustion engine which uses gasoline and alcohol as a fuel and can yield sufficient output even though the alcohol is injected into an intake port. The internal combustion engine (1) includes a first fuel injection unit (6) configured to inject gasoline into an intake port (4) or inject gasoline directly into a combustion chamber (2) and a second fuel injection unit (8) configured to inject alcohol into the intake port (4). The alcohol flows into the combustion chamber (2) after being injected directly onto a wall surface of an intake valve (4a) or a wall surface of the intake port (4) in liquid state by the second fuel injection unit (8).

### BACKGROUND OF THE INVENTION

1. Field of the Invention

The present invention relates to an internal combustion engine using gasoline and alcohol as a fuel.

2. Description of the Related Art

Conventionally, there has been known an internal combustion engine using gasoline and alcohol as a fuel. For example, a spark-ignition internal combustion engine which is provided with a first injector injecting gasoline directly into a combustion chamber and a second injector injecting ethanol into an intake port may be given as the internal combustion engine (for example, refer to Japanese Patent Laid-open No. S61-164037).

The ethanol can be prepared from fermentation of plant substances, for example, agricultural crops such as sugar cane, corn and the like, or biomass resources containing cellulose such as rice straw, wheat straw and the like. A raw material plant in the plant substances has absorbed carbon dioxide through photosynthesis; when the ethanol prepared from the raw material plant is burned, the emitted amount of carbon dioxide is equal to the absorbed amount of carbon dioxide by the raw material plant itself. In other words, the so-called carbon neutral effect can be achieved since the total emitted amount of carbon dioxide is theoretically equal to zero. Thereby, the emitted amount of carbon dioxide can be reduced, which contributes to prevention of global warming.

The ethanol is supplied as a composite fuel with liquid hydrocarbon such as gasoline or the like. When water is added and mixed with the composite fuel, the gasoline and ethanol water solution can be easily separated.

The alcohol such as ethanol or the like has a higher octane number in comparison with the gasoline; therefore, by adjusting a ratio of the gasoline and the alcohol, it is possible for the internal combustion engine using the gasoline and the alcohol as a fuel to cope with wide range of engine loads. The greater the engine load in the internal combustion engine becomes, the ratio of alcohol should be adjusted higher to prevent knocking.

However, in the internal combustion engine mentioned above, when the alcohol is injected to the intake port, it vaporizes immediately to have a volume increment, preventing sufficient amount of air from being taken in, and consequently, deteriorating output.

### SUMMARY OF THE INVENTION

The present invention has been accomplished in view of the aforementioned problems, and it is therefore an object of the present invention to provide an internal combustion engine which uses gasoline and alcohol as a fuel and can yield sufficient output even though the alcohol is injected into an intake port.

To attain an object described above, an internal combustion engine according to the present invention is provided with a first fuel injection unit configured to inject gasoline into an intake port or inject gasoline directly into a combustion chamber, and a second fuel injection unit configured to inject alcohol into the intake port, wherein the alcohol flows into the combustion chamber after being injected directly onto a wall surface of an intake valve or a wall surface of the intake port in liquid state by the second fuel injection unit.

According to the internal combustion engine of the present invention, by injecting the alcohol onto the wall surface of the intake valve or the wall surface of the intake port in liquid state through the second fuel injection unit, sufficient amount of air can be taken in. Thereby, even though the alcohol is injected into the intake port, the output will not be deteriorated, enabling sufficient output to be yielded.

In the internal combustion engine of the present invention, it is acceptable that the alcohol flows into the combustion chamber in liquid state or flows into the combustion chamber after being vaporized through direct injection onto the wall surface of the intake valve or the wall surface of the intake port in liquid state.

In the internal combustion engine of the present invention, it is preferred that the alcohol flows into the combustion chamber after being injected directly onto the wall surface of the intake valve or the wall surface of the intake port in liquid state by the second fuel injection unit in such a way that a diameter of a dispersion zone of the alcohol located at a distance of 100 mm to an injection position is no greater than 10 mm.

Consequently, by injecting the alcohol directly onto the wall surface of the intake valve or the wall surface of the intake port in liquid state, the internal combustion engine of the present invention can take in sufficient amount of air. Thereby, even though the alcohol is injected to the intake port, the output will not be deteriorated, enabling sufficient output to be yielded.

If the diameter of the dispersion zone of the alcohol located at a distance of 100 mm to the injection position is greater than 10 mm, the alcohol may not be injected directly in liquid state onto the wall surface of the intake valve or the wall surface of the intake port. Thereby, due to the vaporization of the alcohol, sufficient amount of air may not be taken in.

Therefore, in the internal combustion engine of the present invention, it is preferred that the alcohol is injected by the second fuel injection unit at an injection angle of no greater than 3° relative to a central line of the second fuel injection unit in axial direction. According thereto, the second fuel injection unit can inject the alcohol so that the diameter of the dispersion zone of the alcohol located at a distance of 100 mm to the injection position is no greater than 10 mm. However, if the injection angle is greater than 3°, the diameter of the dispersion zone of the alcohol may become greater than 10 mm.

Further, in the internal combustion engine of the present invention, it is preferred that the second fuel injection unit is provided with a nozzle satisfying that a ratio L/D of a length L of the nozzle to an inner diameter D thereof is no less than 6 and the inner diameter D of the nozzle is no greater than 1.0 mm to inject the ethanol.

Furthermore, in the internal combustion engine of the present invention, ethanol can be used as an example of the alcohol. When the ethanol is yielded from the fermentation of plant substances, according to the carbon neutral effect, the emitted amount of carbon dioxide can be reduced.

### BRIEF DESCRIPTION OF THE DRAWINGS

FIG. 1 is a cross-sectional view illustrating an example of an internal combustion engine of the present invention.

FIG. 2 is an explanatory view illustrating a dispersion zone of ethanol injected from an injector.

FIG. 3 is a cross-sectional view illustrating a configuration of the injector injecting the ethanol.

FIG. 4 is a cross-sectional view illustrating a part of another example of the internal combustion engine of the present invention.

FIG. 5 is a cross-sectional view illustrating a part of another example of the internal combustion engine of the present invention.

FIG. 6 is a graph illustrating comparison between the intake amount of air by the internal combustion engine of the present invention and the intake amount of air by an internal combustion engine of the conventional art.

FIG. 7 is a graph illustrating comparison between the maximum load (output) by the internal combustion engine of the present invention and the maximum load (output) by an internal combustion engine of the conventional art.

### DETAILED DESCRIPTION OF THE PREFERRED EMBODIMENTS

Hereinafter, an embodiment of the present invention will be described in detail with reference to the drawings.

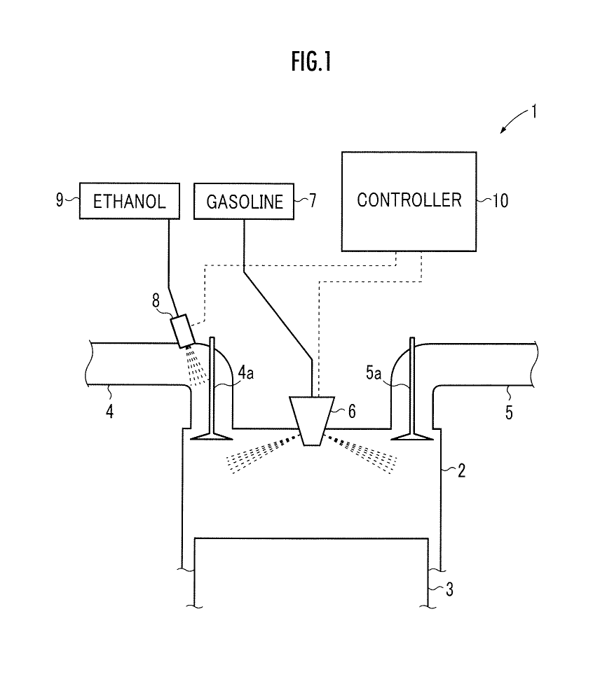

As illustrated in FIG. 1, an internal combustion engine 1 of the present embodiment is a compression-ignition internal combustion engine and is provided with a combustion chamber 2 having a cylindrical shape and a piston 3 slidable along an inner wall of the combustion chamber 2. An upper portion of the combustion chamber 2 is provided with an intake port 4 and an exhaust port 5 in communication with the combustion chamber 2. The intake port 4 and the exhaust port 5 are opened and closed by an intake valve 4a and an exhaust valve 5a, respectively.

A first injector 6 is disposed roughly in the center of the upper portion of the combustion chamber 2 as a first fuel injection unit for injecting gasoline directly into the combustion chamber 2. The first injector 6 is connected to a gasoline tank 7. The intake port 4 is disposed with a second injector 8 serving as a second fuel injection unit for injecting ethanol into the intake port 4. The second injector 8 is connected to an ethanol tank 9.

The internal combustion engine 1 is provided with a main tank (not shown) to which a composite fuel of ethanol and gasoline mixed at a predefined rate is supplied. After the composite fuel is pumped out from the main tank, water is added therein and agitation is applied thereafter to separate the composite fuel to gasoline and ethanol water solution. The gasoline separated from the composite fuel is stored in the gasoline tank 7, and the ethanol water solution is stored in the ethanol tank 9 as the ethanol.

The internal combustion engine 1 is provided with a controller 10 configured to control operations of the first injector 6 and the second injector 8. The controller 10 controls operations of the first injector 6 and the second injector 8 according to output signals output from an accelerator sensor (not shown) and a torque sensor (not shown), number of rotations, a crank angle, and an inner temperature or the like of the combustion chamber 2.

Hereinafter, the operation of the internal combustion engine 1 of the present embodiment is described.

Firstly, in a compression stroke of the internal combustion engine 1, the controller 10 controls the first injector 6 to inject gasoline directly into the combustion chamber 2 and the second injector 8 to inject ethanol into the intake port 4. Herein, the controller 10 adjusts a ratio of gasoline injected from the first injector 6 and ethanol injected from the second injector 8 according to a detected engine load. Specifically, the controller 10 increases the proportion of ethanol as the engine load becomes greater and increases the proportion of gasoline as the engine load becomes smaller.

In the internal combustion engine 1, the second injector 8 injects ethanol directly onto a cone portion of the intake valve 4a in liquid state and the injected ethanol flows into the combustion chamber 2 thereafter. It is acceptable that the ethanol flows into the combustion chamber 2 in liquid state or enters the combustion chamber 2 after being vaporized according to the impact to the intake valve 4a.

After the ethanol is vaporized in the intake port 4, the volume thereof increases, which hinders the intake of air. However, according to the internal combustion engine 1 of the present embodiment, the ethanol is injected directly onto the intake valve 4a in liquid state by the second injector 8; therefore, the intake of air will not be hindered.

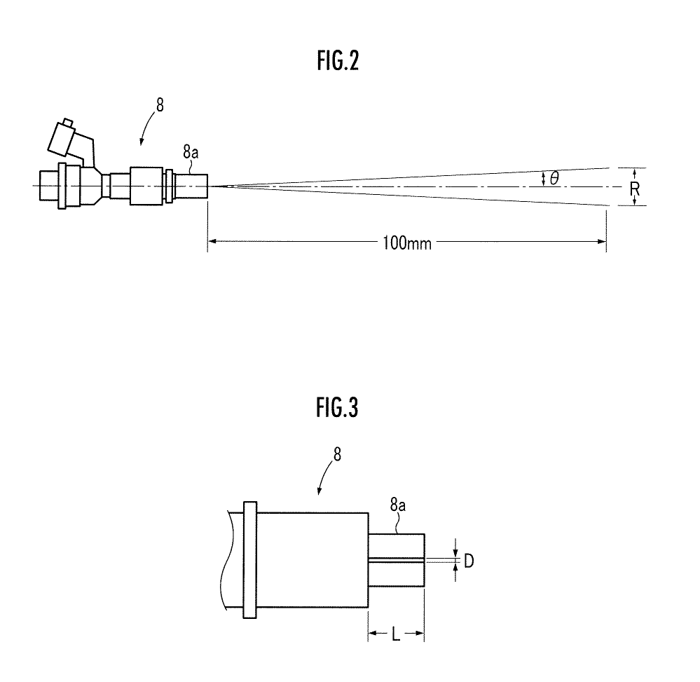

In the present embodiment, in order to inject ethanol directly onto the intake valve 4a in liquid state from the second injector 8, as illustrated in FIG. 2, the second injector 8 is configured to inject ethanol in such a way that a diameter R of a dispersion zone of ethanol located at a distance of 100 mm to a tip end of the nozzle 8a is no greater than 10 mm. To obtain the mentioned dispersion zone, the second injector 8 is configured to inject ethanol an injection angle of no greater than 3° relative to a central line of the nozzle 8a in axial direction.

As illustrated in FIG. 3, the second inject 8 is configured in such a way that a ratio L/D of a length L of the nozzle 8a to an inner diameter D thereof is no less than 6 and the inner diameter D is no greater than 1.0 mm

Accordingly, the vaporized gasoline and ethanol mix with sufficient amount of air in the combustion chamber 2 to form a gas mixture, the gas mixture is subjected to compression self-ignition in the combustion chamber 2 to yield sufficient output.

As illustrated in FIG. 4, it is acceptable that the internal combustion engine 1 of the present embodiment is provided with two intake valves 41a and 42a, and two exhaust valves 51a and 52a at a cylinder head 2a formed on the roof portion of the internal combustion 2. The two intake valves 41a and 42a are connected to intake manifolds 41 and 42, respectively. The two exhaust valves 51a and 52a are connected respectively to exhaust manifolds not shown for simple explanation. The second injectors 81 and 82 are disposed respectively in the intake manifolds 41 and 42.

When the internal combustion engine 1 is provided with two intake valves 41a, 42a and two intake manifolds 41, 42, it is acceptable that a valve stopping mechanism is disposed to stop either one of the intake valves 41a and 42a. When the internal combustion engine 1 is provided with two intake valves 41a, 42a and two intake manifolds 41, 42, it is acceptable that either of the intake manifolds 41 and 42 is used as a swirl port. When either of the intake manifolds 41 and 42 is used as a swirl port, ethanol directly injected onto the intake valves 41a and 42a is vaporized due to reinforced flow by swirling.

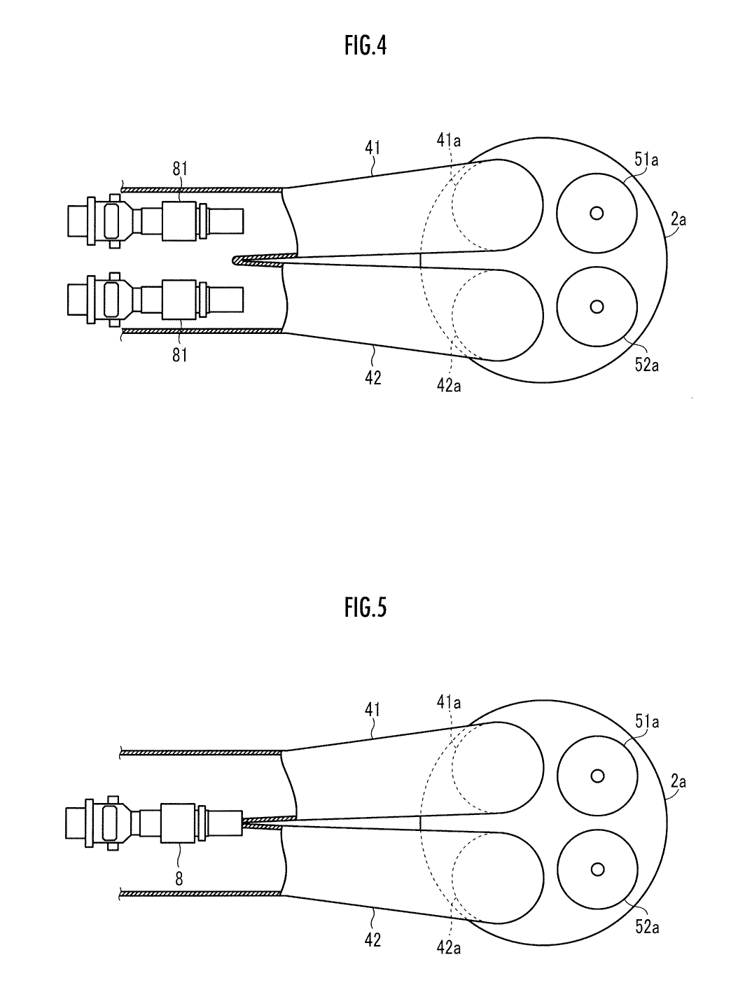

When the internal combustion engine 1 is provided with two intake valves 41a, 42a and two intake manifolds 41, 42, it is acceptable that a single second injector 8 is disposed at the upstream side of a bifurcation portion of the intake manifolds 41 and 42 to inject ethanol to each of the intake manifolds 41 and 42, as illustrated in FIG. 5.

In the present embodiment, the first injector 6 is configured to inject gasoline directly into the combustion chamber 2; however, it is also acceptable that first injector 6 is configured to inject gasoline into the intake port 4. In this situation, as illustrated in FIG. 4, either one of the second injectors 81 and 82 may be used as the first injector 6 and the other one as the second injector 8.

In the present embodiment, it is described that ethanol is used as alcohol; however, it is acceptable to use the other alcohol, for example methanol as a substitute of the ethanol. The internal combustion engine 1 of the present embodiment may be used in a supercharged engine.

In the present embodiment, the internal combustion engine 1 is described as a compression ignition internal engine; however, the internal combustion engine 1 may be a spark-ignition engine which is ignited by an ignition plug (not shown) disposed at the cylinder head 2a.

A preferred example is given below.

### Preferred Example

In the present preferred example, a single cylinder engine for testing (bore 86 mm×stroke 86 mm) is used as the internal combustion engine 1, operated at the number of rotations of 1500 rpm, full open throttle, and ethanol injection ratio of 40 v/v%. The second injector 8 injects ethanol in liquid state directly onto the cone portion of the intake valve 4a.

The distance between the tip end of the nozzle 8a and the cone portion of the intake valve 4a is about 100 mm. The diameter of the dispersion zone of ethanol at 100 mm to the tip end of the nozzle 8a is 10 mm. In the nozzle 8a, the ratio L/D of the nozzle length L to the nozzle inner diameter D is 10 and the nozzle inner diameter D is 0.5 mm.

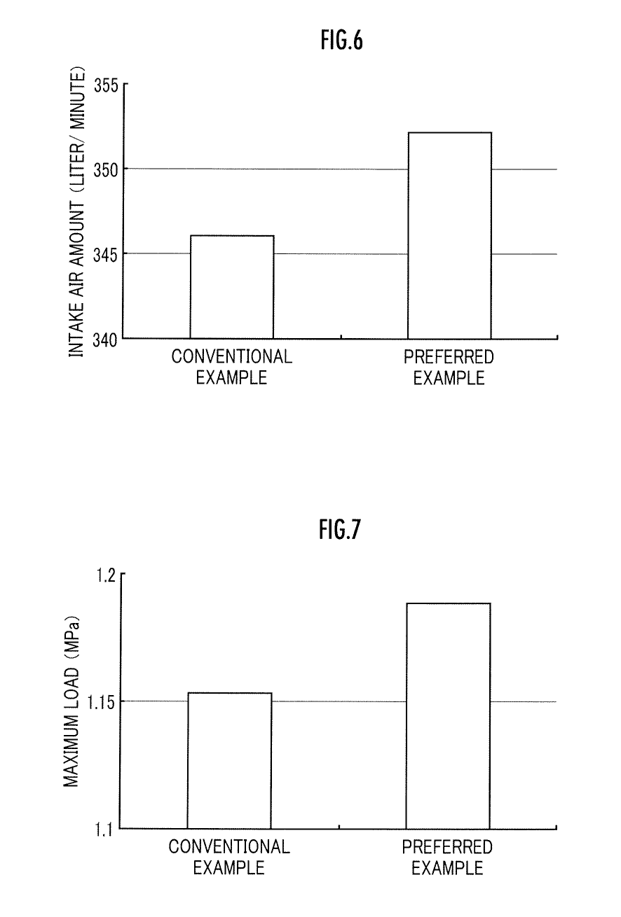

The intake amount of air into the combustion chamber 2 and the maximum load (output) for the present preferred example and a conventional example where ethanol is vaporized in the intake port 4 are compared. The comparison result of the intake amount of air is illustrated in FIG. 6, and the comparison result of the maximum load is illustrated in FIG. 7.

It is obvious from FIG. 6 that the intake amount of air for the internal combustion engine 1 of the present preferred example is increased by 1.7% in comparison with the conventional example. Consequently, it is obvious from FIG. 7 that the maximum load for the internal combustion engine 1 of the present preferred example is increased by 3.0% in comparison with the conventional example.

What is claimed is:

1. An internal combustion engine comprising:
a first fuel injection unit configured to inject gasoline into an intake port or inject gasoline directly into a combustion chamber, and
a second fuel injection unit configured to inject alcohol into the intake port,
wherein the alcohol flows into the combustion chamber after being injected directly onto a wall surface of an intake valve or a wall surface of the intake port in liquid state by the second fuel injection unit.

2. The internal combustion engine according to claim 1, wherein the alcohol is vaporized after being injected directly onto the wall surface of the intake valve or the wall surface of the intake port in liquid state by the second fuel injection unit.

3. The internal combustion engine according to claim 1, wherein the alcohol flows into the combustion chamber after being injected directly onto the wall surface of the intake valve or the wall surface of the intake port in liquid state by the second fuel injection unit in such a way that a diameter of a dispersion zone of the alcohol located at a distance of 100 mm to an injection position is no greater than 10 mm.

4. The internal combustion engine according to claim 3, wherein the alcohol is injected by the second fuel injection unit at an injection angle of no greater than 3° relative to a central line of the second fuel injection unit in axial direction.

5. The internal combustion engine according to claim 3, wherein the second fuel injection unit is provided with a nozzle satisfying that a ratio L/D of a length L of the nozzle to an inner diameter D thereof is no less than 6 and the inner diameter D of the nozzle is no greater than 1.0 mm.

6. The internal combustion engine according to claim 1, wherein the alcohol is ethanol.
